(19) United States
(12) Patent Application Publication
(10) Pub. No.: US 2016/0310991 A1
(43) Pub. Date: Oct. 27, 2016

(54) Process for the polymer coating of non-ferrous metal surfaces

(71) Applicant: Héctor Delgado Morales, Xalatlaco (MX)

(72) Inventor: Héctor Delgado Morales, Xalatlaco (MX)

(21) Appl. No.: 14/697,324

(22) Filed: Apr. 27, 2015

(51) Int. Cl. B05D 7/14; B05D 5/00; B05D 1/36; B05D 3/10; B05D 3/02

(52) U.S. Cl. CPC B05D 7/14; B05D 3/102; B05D 3/0218; B05D 3/0254; B05D 1/36; B05D 5/00

(57) ABSTRACT

The present invention relates to a method for coating a surface of a nonferrous metallic substrate, with a bilayer polymeric coating, said method comprising: 1) Subjecting the surface of a nonferrous metal object to a chemical washing; 2) Heating the article whose surface will be coated, to a temperature higher than the melting temperature of the selected polymer and lower than the ignition temperature thereof; 3) Apply the first layer, with a size of less than or equal to 20 mesh particle, constantly keeping the substrate temperature; 4) Applying a second layer of plastic coating on the first coating layer, after the first layer has adhered to the substrate surface, where the second layer can be the same or different polymer, with a particle size equal to or less 20 mesh; 5) Heating further the set of substrate and bilayer coating to a temperature higher than the selected at step 2, but lower than the ignition temperature of the coating and 6) Cooling the thus coated substrate to room temperature. The product obtained by the described process, provides a smooth, nonporous surface, a high adhesion of the coating to the substrate and covering all exposed to the chemical treatment of the first stage surface is ensured, so that the resulting coated substrate is suitable for use in the food industry.

### TECHNICAL FIELD OF THE INVENTION

The present invention relates to methods of applying polymer coatings on non-ferrous metal surfaces, and particularly relates to one such process where the polymer coating is performed by applying two layers of polymer, the first one an adhesive layer and the second a working layer which provides the required finish, achieving a superior bond between the metal surface and the first layer and allowing a wide variety of surface finishes by the second layer,

### BACKGROUND OF THE INVENTION

The methods currently used for applying a plastic coating to a substrate commonly used in various industrial fields are those such as dipping powder, OF fluidized bed and heat-shrinkable film. The main disadvantages with these methods lies in the difficulty of operating with very different sizes of parts and very poor adhesion strength of the plastic coating to the surface of products made of non-ferrous metal.

There are numerous attempts aimed to obtain plastic blends and methods for applying coatings. For example, U.S. Pat. No. 2,983,704 (Roedel, 1961) Disclose the use of polyethylene of high and low density mixtures. The U.S. Pat. No. 3,348,995 (Baker, et. al., 1967) disclose a coating method for metallic surfaces with polyethylene, using a polyethylene primer. The method used to coat the metal surface is a process of two layers with the first layer being of high density polyethylene and the second layer of medium or low density polyethylene, or a mixture of both.

U.S. Pat. No. 3,410,709 (Meyer, et al., 1968) disclose a method for a polymer coating on a metal, in which an organic crosslinking agent is mixed with powdered polyethylene and then this mixture is used to improve bonding to the metal surface.

U.S. Pat. No. 3,639,189 (Hartman, 1972) disclose adhesives compositions that includes polyethylene and oxidized polyethylene, which comprise elastomer as an additional component in the formulations. U.S. Pat. No. 4,007,298 (Feehan, et. al., 1977) relates to polyethylene coatings for ferrous metals; This patent discloses the mixing together a high density polyethylene and a low density polyethylene to take advantage of the binding properties of high density polyethylene and the flexibility and low cost low density polyethylene.

U.S. Pat. No. 4,182,782 (Scheiber, 1980) relates to a method for coating the outer surface of a metal pipe, wherein the process comprises coating a pipe with powder plastic using a fluidized bed. U.S. Pat. No. 4,211,595 (Samour, 1980) y U.S. Pat. No. 4,213,486 (Samour, et. al., 1980) disclose a method of first coating the pipe with epoxy resin or other coating and then extruding an outer layer of polyethylene or other plastic. The U.S. Pat. No. 4,307,133 (Haselier, 1981) refers to a method for applying a polymer coating to a metal surface, and the polymer powder suitable for the method; this patent describes the use of a powder mixture of stabilized or stabilized polyolefin for coating a hot metal surface. U.S. Pat. No. 4,319,610 (Eckner, 1982) is directed to a process for coating metal pipes and the use of so coated tubes; this patent describes the process for coating tubes or pipes using specific temperatures and plastic melt indices. U.S. Pat. No. 4,865,882 (Okano, et. al., 1989) disclose a method for the powder coating of metallic goods, where polypropylene is used as a primary coating with some polyethylene added as part of the coating. The U.S. Pat. No. 4,910,046 (Herwig, et. al., 1990) relates to resin formulations for a powder coating process of metal parts using a low density polyethylene and other compounds. U.S. Pat. No. 4,921,558 (Johnson, 1990) relates to the polyethylene use as additive for long carbon fiver laminates/poly arylen sulphide to prevent cracking. U.S. Pat. No. 5,750,252 (Danner, et. al., 1998) describes the application of a modified polyethylene film to a metal substrate with a second layer joined to the first.

However none of the efforts described have been designed to solve the problem of adhering a uniform layer of plastic jointless to the surface of non-ferrous metals, wherein the adhesive strength of the plastic coating layer is so high that it is almost impossible to detach. In addition, there is a need for a plastic coating that will not break, split, tear or crack, that is one hundred percent safe for contact with food. A further need exists for a non-slip plastic coating that has sufficient strength to not degrade on contact with the acid or water and also support temperatures up to 110° C. using a pure polyethylene topcoat. Higher temperatures are possible with the use of additives or by use of other plastic resins, unaltered in its structure. Finally, there is a further need for a plastic coating when applied to a sheet, produces a product completely flexible and that fits any environment.

### OBJECTS OF THE INVENTION

Given the shortcomings of the prior art, an object of the invention is to provide a process for coating nonferrous metal surfaces, of simple operation and high efficiency.

Another object of the present invention is to provide a process for coating nonferrous metal surfaces, capable of being employed on parts in a wide variety of sizes and shapes.

Other object of the present invention is to provide a process to cover nonferrous metal surfaces, wherein the plastic coating layer possesses a very high adhesion to the nonferrous metal surface coated.

A further object of the present invention is to provide a composition of plastic coating to be applied to non ferrous metal surfaces, wherein the plastic coating layer possesses desirable mechanical properties such as breaking strength or slip resistance.

Still another object of the present invention is to provide a composition of plastic coating to be applied to nonferrous metallic surfaces which is chemically stable to be in contact with food.

A still further object of the present invention is to provide a plastic coating which also support temperatures up to 110° C. using a pure polyethylene topcoat, or higher temperatures with the use of additives or by the use of other plastic resins, unaltered in its structure.

Finally, in another object of the present invention to provide a plastic coating useful for application on a sheet to produce a product totally flexible and that fits any contours.

These and other objects will be apparent in light of the following description and the accompanying figures, which are not intended to be limiting of the invention but illustrative of it.

### SUMMARY OF THE INVENTION

The present invention refers to a method of coating of a surface of a nonferrous metal substrate, with a bilayer polymer coating, where the layers may be the same or different polymer, wherein said method comprises the following steps:
1. Subject the surface of a nonferrous metal object, to a chemical washing
2. Heat the item to a temperature higher than the melting temperature of the selected for the first layer of the coating, but below the ignition temperature thereof,
3. Apply the first layer of polymeric coating having a particle size of the polymer resin, less than or equal to 20 meshes, keeping the temperature constant of the substrate,
4. Apply a second layer of plastic coating on the first coating layer of the previous step, once this first layer has adhered to the surface of the nonferrous metal substrate, where it is the second layer it can be the same or different polymer, with a particle size equal to or less than 20 mesh;
5. Heat further the assembly of substrate and bilayer coating at a temperature between the melting temperature of the polymer selected for the first layer, but lower than the ignition temperature thereof, to produce a smooth surface finish, and
6. Cool the so coated substrate to room temperature.

The product obtained by the process described, provides a smooth, non-porous surface, a high adherence of the cover to the substrate and the coating of all exposed surface to the chemical treatment of the first stage is ensured, so that the resulting coated substrate is suitable for use in the food industry, among other.

### BRIEF DESCRIPTION OF THE FIGURES

FIG. 1 is a flowchart of the covering process of the invention.

FIG. 2 is a schematic representation of the nonferrous metal substrate with the two layers of coating after the process of the inventions is finished.

FIG. 3 is a picture of an example of an item with plastic covering applied all over the exposed surface, through the process of the invention.

### DETAILED DESCRIPTION OF THE INVENTION

The present invention relates to a process for the coating with a polymeric material of the surface of product made of nonferrous metals, where the covering comprises a polymer bilayer; the first layer, called “adhesive layer” produces uniform jointless covering showing high adhesion to the substrate surface under treatment, and the second layer, called the “working layer” is a polymeric material equal to or different from the first layer, which provides desirable qualities of the coating, such as flexibility, tensile strength, anti-slip surface, and that is tolerant to attack by chemicals such as acids or other materials present in food.

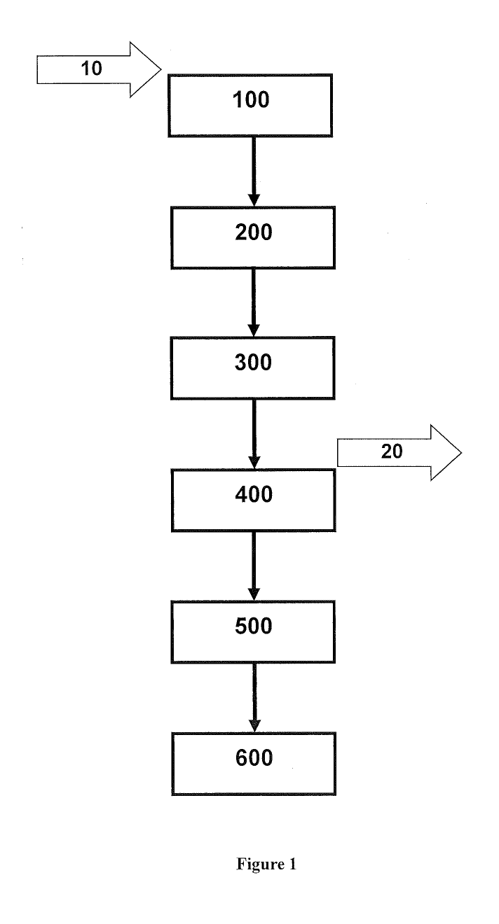

The covering procedure of a nonferrous metal substrate of the invention is shown on FIG. 1, that is a block diagram, where an nonferrous metal object (10), is subjected to the steps of the processes:
1. Treat the surface of the nonferrous metal object (10), with a chemical wash (100),
2. Heat (200) the metal object (10) already treated in the above step to a temperature above the melting temperature of the polymer selected for the first layer, but lower than the ignition temperature thereof,
3. Apply the first layer of polymeric coating (300), consisting of a mixture of polymer powder and an appropriate conventional foaming with a particle size of the polymer resin less than or equal to 20 meshes, keeping the temperature constant of the substrate; remove excess of the mixture, and allow the polymer to evenly distribute on the surface of the object until this first layer has adhered to the surface of the object,
4. Apply a second layer of plastic coating (400) on the first coating later of the previous step, where it is the second layer, it can be the same or different polymer, with a particle size equal to or less than 20 mesh;
5. Heat (500) the assembly of substrate and bilayer coating at a temperature between the melting temperature of the polymer selected for the first layer, but lower than the ignition temperature thereof, to allow the polymer to flow over the surface and achieve a smooth surface finish, and
6. Cool (600) the so coated substrate (20) to room temperature.

Nonferrous substrates to which the method of the present invention described above can be applied, are selected from the group consisting of non-ferrous metals such as: aluminium, copper and brass, aluminium alloy and copper, zinc, lead, silver and alloys. Nonferrous substrates particularly preferred in the present invention are those selected from the group consisting of aluminium, copper and brass.

The first phase (100) of surface conditioning, consists of immersing the object in an aqueous solution in an aqueous solution ratio agent/water of from 1:1 to 1:20 with an appropriate chemical agent selected from the group consisting:
a) an acid solution from one or more acid such as phosphoric, muriatic, nitric, tannic and/or hydrochloric, or
b) a caustic soda solution (sodium hydroxide) or other strong base;

the enough time to observe that the metal “pore” is sufficiently open to receive the coating, and washed in water to stop the corrosive effect of the acid.

The firs layer or adhesive layer (310), comprises in addition to the polymer, a conventional foaming additive. For the application of this first layer, any conventional method can by applied, for example: also include the polymer, a conventional foaming additive. Applying to this first layer may be employed any conventional method, such as e.g.: spray or curtain coating, conventional rotomoulding techniques, powder dispersion coating, or is the plastic material is mixed with compatible solvent, applying as a paste-like film. It is suggested that the temperature of the surface to be treated is around 400° C. to promote the formation of a thin coating layer.

The thickness of the film formed on the substrate, is based on a number of variables associated with the method used to apply the polymer. For example, when a spray or courting coating method is used, the thickness of the film can be controlled maintaining the substrate at a constant temperature and maintain constant the flow in cascade of the plastic powder material over the said object for a certain time, while the object is rotated below the flow of the plastic material, thus occurs thickness of coating reasonably uniform.

While the first layer is still hot and melt is carried out applying the second layer, formed by a plastic powder or ground material, using conventional techniques, including the application as extruded film. The second layer or working coat, can be any plastic material having a melt index in the range of 1 to 50 g/10 minutes, and the thickness of the film formed can be as high as 0.636 cm.

Polymers employed in the first and second layer of the covering can contain any conventional additive, that improve the physical properties thereof and change aesthetic characteristics of surface finish. Additionally, it is important that polymers that are used in accordance with the process described, having a particle size between 20 and 400 mesh, preferably 80 to 100 mesh (although in some applications, sizes in the range of 20 to 30 meshes are acceptable), by following reasons:
a) This particle size allows the plastic material melt quickly and uniformly,
b) Several colours can be mixed so that its melt dispersion provide aesthetic finishes,
c) The impact of the differences of the melting indexes is reduced, offering a softer plastic material.

The temperature of the non ferrous substrate to be covered, must be maintained constant during the steps of applying the first and second coating layers until all of the molten plastic material are uniformly.

In alternative embodiments, the substrate may be:
i) preheated, if both sides of the objects will be covered;
ii) heated only from the side that will not be covered; or
iii) in case the object to be covered possess sufficient thermal mass to completely melt the plastic,

may be subject to preheat and apply two coats without reheating the object (if the temperature is sufficient to ensure the molten plastic material). In the specific case where the product to be coated is a sheet, heat must be applied to the opposite side of which being coated.

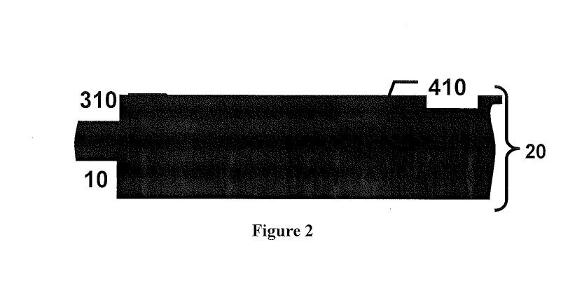

Regarding to FIG. 2, that is a schematic representation of a cross-sectional view of a substrate (20) treated with de process of the present invention, the firs polymeric layer (310) that is applied to the nonferrous metallic substrate (10) is considerate the adhesive layer between such metallic substrate (10) and the second polymeric layer (410), called working layer, will present the desired finish of the exposed surface of the object (20).

### Preferred Embodiment

In a preferred method of applying the process of the present invention, the material selected for both coating layer is polyethylene, with is ground to a particle size equal to or less than 20 mesh, and has a density or between 0.91 y 0.965 g/cm³, with a melt index of between 0.5 and 50 g/10 minutes.

In particular, a preferred formulation for the first layer in a preferred embodiment of the present invention is a polyethylene with a density of between 0.937 and 0.939 g/cm³, with a melt index of 1 and 10 g/10 minutes.

For the second polymeric layer is preferred using polyethylene with low and high melting rates, that can be applied individually or mixed. A mix for the second layer in a preferred embodiment comprises a polyethylene with a melt index of 3 to 5 g/10 minutes and a polyethylene with a melt index of 20 to 30 g/10 minutes; this mixture allows to obtain different grains or grain coloured plastic in the coating, which adds values to the product by allowing colourful finished.

Alternatively, the second layer consists of polyethylene with melt index of 20 to 30 g/10 minutes, that provides some desirable surface features such as a smoother surface and more consistent colour.

### Some Examples of the Application of the Process of the Invention

### Example 1

The surface of an object made of aluminium is subjected to conditioning by chemical attack using a hydrochloric acid solution in water.

For both coating steps, polyethylene was used, crushed up to a particle size between 80 mesh and 100 mesh. For the fist layer polyethylene have a melt index of 4.0 g/10 minutes and a density of 0.938 g/cm³ with a foaming additive.

After chemical treatment, the object surface is heated to between 180 and 300° C. and once it has a uniform temperature, the first layer of plastic powder is applied in order to obtain a thin uniform layer over the entire exposed surface. The thickness is determined by the time that the surface is exposed to the sprayed material.

Immediately after the first layer, a second layer of plastic material is applied, with no additional heat to the object, until the surface is fully covered.

When the temperature of the surface of the object has been reduced to 120° C., is heated again to carry to 180-280° C. with what the coating is remitted to achieve a smooth surface. Subsequently cooling the surface is allowed at room temperature.

### Example 2

The surface of an aluminium sheet is subjected to a conditioning or treatment with an acid solution until the sheet surface is treated by a chemical attack uniformly.

For the covering phase of the process of the present invention, polyethylene plastic is used for the first and second layer of the plastic cover, which was crushed or ground to a particle size passing through 80 mesh to 100 mesh, even smaller.

The primary coating consists of polyethylene with a melt index of 4.0 g/10 minutes and a density of 0.938 g/cm3 with an additive added to produce a foaming action.

The second layer of the plastic coating consists of a mixture 1:1 of a coloured polyethylene with a melting index of 4.0 g/10 minutes and a density of 0.938 g/cm3, and a natural polyethylene with a melting index of 25 g/10 minutes and a density of 0.917 g/cm3.

After chemical treatment, the treated surface of the aluminium foil is heated from 180° C. to 300° C. After uniformly heat treated surface of the sheet, the first layer of plastic material is applied. This first layer is applied polyethylene emptying the powder mixture on the hot surface of the treated aluminium foil until a first layer is completely uniform thin coating applied.

Immediately after the second layer of plastic material is applied by placing a thick layer of the second powder mixture on the first layer. The coated blade is then heated for 5 seconds and excess plastic powder is removed from the surface. The coating thickness was controlled by the time they remained on the plastic material and the surface temperature of the aluminium foil.

After that, the aluminium foil with the coating was subjected to an additional heat source (220 to 300) until it was completely melted plastic surface. After the coating has gelled slightly, then the coated surface is subjected to a heat source that remelted the plastic surface to a temperature of between 180 and 280° C. to create a smooth surface. The coated sheet is allowed to cool to room temperature.

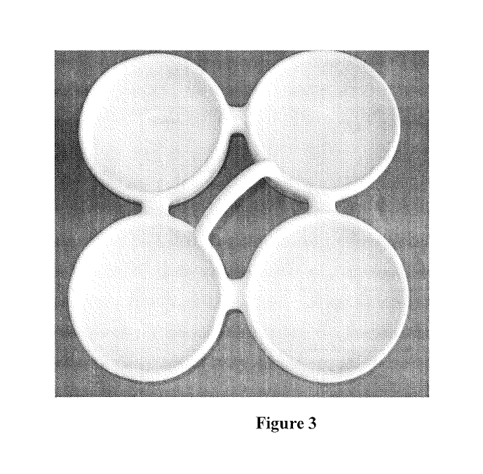

In the FIG. 3, can be seen an example of the finished obtained by plastic coating process of the present invention, an object with a relatively exposed surface treated irregularly.

### Binding Assays

Samples that were tested by tension were constructed as described in Example 1 above. These samples are composed of an aluminium substrate moulded with the first and second layers formed of polyethylene. A special heel or test coupon was fabricated by fixing a post to a square piece of aluminium 2.54 cm×2.54 cm. This accessory was placed on top of a piece of aluminium treated by acid attack and the total assembly was coated. This allows the part to will be loaded under tension by eliminating the problems of adhesive bonding to polyethylene. The tensile stress or exceeded 475 psi.

The other binding test consisted of passing a razor blade single edge between the plastic and the substrate at the interface of the two materials. If the connection is poor, the plastic coating will easily be separated from the substrate. Using this method, the tests conducted on samples in which the substrate surface was chemically treated 15% to 100%. The results produced no failures in any of the degrees of the surface treated with chemicals.

Even though the invention has been described in connection with specific in the same modalities, it will be understood that it is capable of further modifications and this application is intended to protect any variations, uses, or adaptations of the invention following, in general, the principles of the invention and including such departures from the disclosure herein as occurring within the known and customary practice within the art to which the invention pertains, and as may be applied to the essential features there set forth above, and as follows in the scope of the appended claims.

What is claimed is:

1. A process for the covering with polymeric material of the surface of products manufactured of nonferrous metals, where the covering consists of a polymer bilayer; one first adhesive layer that produces an uniform jointless cover with high adherence to the substrate surface under treatment, and a second working layer, of a polymeric material same or different of the first layer, that provides desirable qualities to the coating, said process characterized by comprising the steps:
a).—Treat the nonferrous metal object surface, with a chemical washing,
b).—Heat the metal object to a temperature over the melting temperature of the polymer selected for the first layer of the cover, but lower than the ignition temperature thereof,
c).—Apply the first layer of the polymer cover, maintaining the substrate temperature constant; remove excess of the mixture, and allow the polymer to evenly distribute on the surface of the object until this first layer has adhered to the surface of the object,
d).—Apply a second layer of the polymer cover over the first layer of the cover of the previous step;
e).—Heat the assembly of the substrate and bilayer coating at a temperature between the melting temperature of the polymer selected for the layer, but lower than the ignition temperature thereof, allowing to flow over the surface and achieve a smooth surface finish and,
f).—Cool the so coated substrate to room temperature.

2. A process for coating polymeric material of the surface of products manufactured of no ferrous metals, in accordance with claim 1, characterized in that the surface treatment consists of a bath by immersing the object in an aqueous solution of a chemical agent in water, in a proportion from 1:1 to 1:20.

3. A process for the coating with polymeric material of the surface of products manufactured of nonferrous materials, in accordance with claim 2, characterized in that the chemical agent is one or mar acid selected from the group that include to the phosphoric, acetic, muriatic, nitric, tannic and/or hydrochloric acids.

4. A process for the coating with polymeric material of the surface of products manufactured of nonferrous materials, in accordance with claim 2, characterized in that the chemical agent is sodium hydroxide (soda) or other strong base.

5. A process for the coating with polymeric material of the surface of products manufactured of nonferrous materials, in accordance with claim 1, characterized in that the nonferrous metallic substrate is selected from the group consisting form aluminium, copper and brass, aluminium alloy and copper, zinc, lead, silver and alloys.

6. A process for the coating with polymeric material of the surface of products manufactured of nonferrous materials, in accordance with claim 1, characterized in that the nonferrous substrates particularly preferred are those selected from the group consisting of aluminium, copper and brass.

7. A process for the coating with polymeric material of the surface of products manufactured of nonferrous materials, in accordance with claim 1, characterized in that the first coating comprises a blend of polymer powder and a conventional foaming agent.

8. A process for the coating with polymeric material of the surface of products manufactured of nonferrous materials, in accordance with claim 7, characterized in that the polymer of the first coating is polyethylene powder.

9. A process for the coating with polymeric material of the surface of products manufactured of nonferrous materials, in accordance with claim 8, characterized in that the polyethylene powder has a particle size passing through 20 mesh or less, a melt index of 0.5 to 50 g/10 minutes and a density of 0.910 and 0.965 g/cm3, and an additive that produces a foaming action.

10. A process for the coating with polymeric material of the surface of products manufactured of nonferrous materials, in accordance with claim 1, characterized in that the second coating is a simple polymer such as polyethylene, polypropylene, nylon or any other compatible polymer or a mixture of different compatible polymers, such as polyethylene and polypropylene, or polyethylene and nylon.

11. A process for the coating with polymeric material of the surface of products manufactured of nonferrous materials, in accordance with claim 1, characterized in that the second coating is a mixture of polyethylene with different melting indexes and densities with the purposes of creating an specific superficial appearance.

12. A process for the coating with polymeric material of the surface of products manufactured of nonferrous materials, in accordance with claim 1, characterized in that the polymers used for the first coating and the second coating may contain additives to provide desired properties in the coating.

13. A process for the coating with polymeric material of the surface of products manufactured of nonferrous materials, in accordance with claim 1, characterized in that the polymers used for the first coating and the second coating, have a particle size between 20 and 400 mesh.

14. A process for the coating with polymeric material of the surface of products manufactured of nonferrous materials, in accordance with claim 13, characterized in that the polymers used for the first coating and the second coating, have a particle size between 80 to 100 mesh.
